(19) United States
(12) Patent Application Publication
(10) Pub. No.: US 2008/0098121 A1
(43) Pub. Date: Apr. 24, 2008

(54) P2P SIP ENABLED MULTIMEDIA NETWORK COMMUNICATION SYSTEM

(75) Inventor: Yichuan WU, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 11/875,686

(22) Filed: Oct. 19, 2007

(30) Foreign Application Priority Data
Oct. 23, 2006 (CN) 200610150677.9

(51) Int. Cl. G06F 15/16

(52) U.S. Cl. 709/229; 709/227

(57) ABSTRACT

A P2P SIP enabled multimedia network communication system is disclosed. The network communication system supports various application, such as IP-based audio, video and instant messages. The network communication system comprises a P2P network and a plurality of user terminals. The P2P network comprises a plurality of ADs acting as nodes thereof. Each of the user terminals is connected to the P2P network by an access AD thereof. The AD comprises a SIP interface, an adapter module and a DHT module. The adapter module performs the transfer between the SIP protocol and the P2P protocol. The DHT module performs a registration operation and look up operation based on a P2P message, and returns the result to the adapter module. The registration operation is used to save registration information of the user terminal in the P2P network. And the look up operation is used to retrieve registration information of another user terminal from the P2P network so as to establish a session between the user terminal and another user terminal.

### TECHNICAL FIELD

The invention relates generally to a network communication system. More specifically, the invention relates to a P2P SIP enabled multimedia network communication system.

### BACKGROUND

IP-based multimedia network communication systems, which are used for communication of audio, video and instant messages, are increasingly popular communications systems for private, corporate, and academic purposes. They are even playing more and more important role in people's daily life. At present, most V2oIP systems are based on either the older H.323 protocol, or the newer SIP protocol from the IETF. SIP is becoming dominant for its simplicity of protocol design. It is a general protocol for establishing and controlling multimedia sessions and can establish voice sessions, video sessions, and remote collaborative/control sessions-essentially any situation where one needs to establish and maintain a session of information among two or more users.

Existing SIP based V2oIP multimedia systems are built based on client server architecture and thus can not avoid the “single point failure” problem, as shown in FIG. 1. That is to say, when the SIP servers happen to fail down, the SIP systems could not work any more. While P2P systems inherently solve the problem because there is no centralized server and the network self-organizes itself. Combining the distributed nature of P2P with standard SIP protocol, P2P SIP has been proposed by some researchers recently. The key idea of P2P SIP is to utilize the P2P to allow for distributed resource discovery in a SIP network, eliminating the need for centralized servers. In addition, P2P SIP systems are more scalable and more robust than the existing centralized SIP systems due to the distributed nature of P2P.

At present there are two schemes proposed to implement P2P SIP. One scheme is “P2P over SIP”, which is to implement P2P using SIP message totally, as shown in FIG. 2. Such system has no dependence on external P2P network.

The implementation of “P2P over SIP” scheme is very proprietary and complex. In this scheme, SIP protocol needs to be extended in order to construct the P2P network, thus reusing existing SIP methods may be confusing and different semantics need more care. Only P2P SIP nodes can participate in the overlay network. What's more, such system is hard to extend. It can not reuse existing different overlay algorithms. In order to support different overlay algorithms, it must do different implementation.

Another scheme is “SIP using P2P”, as shown in FIG. 3, which is to make a SIP layer above the P2P layer and to replace SIP location service by a P2P protocol. Such system reuses optimized and well-defined external P2P network and defines P2P location service interface to be used in SIP. SIP would use the P2P layer for discovery and rendezvous. The external P2P network can use many kinds of P2P DHT algorithms, such as Bamboo, Chord, Pastry, CAN and Tapstry.

“SIP using P2P” scheme is more flexible to implement. In this scheme, SIP is layered above P2P network simply and the SIP protocol does not need to modify. P2P and SIP protocols are totally independent. SIP uses the resource location service provided by P2P via corresponding protocol transform interface. The system is easy to extend because the external P2P network can use many kinds of P2P DHT algorithms, such as Bamboo, Chord, Pastry, CAN and Tapstry. The goal can be achieved just by modifying the protocol transform interface.

The concept of “SIP using P2P” is first shown in Columbia University P2P SIP Project. In this concept (see FIG. 3), the P2P nodes construct the P2P network and provide the P2P services for external access terminals via P2P interface. The terminals access the P2P network using P2P proprietary messages via the P2P own interface. In addition, there exists a protocol transfer module in the terminals to perform the transfer between the SIP protocol and the P2P protocol. The system structure is shown in FIG. 4.

The interface between the terminal and the P2P node is a proprietary interface depending on the selective P2P algorithm. In order to support different P2P algorithms, it must do different implementation. In addition, the AAA (Authentication, Authorization, Accounting) functions for the access terminals are hard to implement in the system when the terminals want to utilize the services provided by the P2P network due to the distributed characterization of P2P. Consequently, the system is subject to a variety of vicious attacks. And the ISPs (Internet Service Providers) and the telecommunication operators could not benefit from this system. In addition, when implementing the system, there exist some difficulties. The difficulties concentrate on the design and implementation of the P2P access interface and the protocol transfer interface between the SIP protocol and P2P algorithms. How to map the standard SIP messages and syntax to P2P network is always a big challenge, and vice versa. In addition, how to design the system architecture and define the system message flow are also needed to take more time to consider.

For these reasons, until now nearly all existing P2P SIP implementations are based on “P2P over SIP”, not “SIP using P2P”.

### SUMMARY

In order to solve these problems mentioned above, the invention proposes and designs a new system structure of “SIP using P2P” scheme. The resulting network is referred to a P2P SIP enabled network. The invention also has implemented a corresponding multimedia network communication system for wireless mesh network.

In accordance with one aspect of the present invention, an access device, which acts as a node in a P2P network, is provided. The P2P network comprises a plurality of the access devices. Each of the access devices is responsible for a hash area, which forms a hash space of the P2P network together with hash areas that other access devices in the P2P network are responsible for.

Moreover, each of the access devices comprises a SIP interface, an adapter module and a DHT module.

The DHT module connects to DHT modules in some of the plurality of the access devices in the P2P network. The adapter module receives a SIP request message from a user terminal which is connected to the P2P network by the access device, converts the SIP request message to a P2P message and then sends it to the DHT module, and converts result from the DHT module to a SIP response message, and sends it to the user terminal through the SIP interface.

The DHT module performs a registration operation and look up operation based on the P2P message, and returns the result to the adapter module. The registration operation is used to save registration information of the user terminal in the P2P network, and the look up operation is used to retrieve registration information of another user terminal from the P2P network so as to establish a session between the user terminal and another user terminal.

In accordance with another aspect of the present invention, a network communication system is provided. The network communication system comprises a P2P network and a plurality of user terminals.

The P2P network comprises a plurality of access devices acting as nodes thereof. Each of the access devices is responsible for a hash area, which forms a hash space of the P2P network together with hash areas that other access devices in the P2P network are responsible for.

The access device comprises a SIP interface, an adapter module and a DHT module.

The DHT module connects to DHT modules in some of the plurality of the access devices in the P2P network. The adapter module receives a SIP request message from a user terminal, which is connected to the P2P network by the access device, converts the SIP request message to a P2P message and then sends it to the DHT module, and converts result from the DHT module to a SIP response message, and sends it to the user terminal through the SIP interface.

The DHT module performs a registration operation and look up operation based on the P2P message, and returns the result to the adapter module. The registration operation is used to save registration information of the user terminal in the P2P network, and the look up operation is used to retrieve registration information of another user terminal from the P2P network so as to establish a session between the user terminal and another user terminal.

Moreover, each of the user terminals is connected to the P2P network by an access AD thereof. The user terminal comprises a user agent for sending/receiving a SIP request message/SIP response message to/from the access AD thereof, in order to register with the P2P network and establish a session between the user terminals.

In accordance with still another aspect of the present invention, a method for registering a user terminal with a network communication system is provided.

The network communication system comprises a P2P network and a plurality of user terminals. The P2P network comprises a plurality of access devices acting as nodes thereof. And each of the user terminals is connected to the P2P network by an access device thereof. Each of the access devices is responsible for a hash area, which forms a hash space of the P2P network together with hash areas that other access devices in the P2P network are responsible for. The access device comprises a SIP interface, an adapter module and a DHT module. The adapter module converts a SIP message received from the user terminal through the SIP interface to a P2P message and sends it to the DHT module, and converts result from the DHT module to a SIP response message, and sends it to the user terminal through the SIP interface.

The method comprises following steps:
the user terminal hashes user name thereof to obtain a User ID;
the user terminal constructs a SIP registration message with the User ID and sends it to the access device thereof, wherein the SIP registration message comprises registration information of the user terminal;
the adapter of the access device thereof converts the SIP registration message received from the user terminal through the SIP interface to a corresponding P2P message and then sends it to the DHT module; and
the DHT module looks up a responsible access device of the user terminal, and makes the registration information be saved in the hash areas that the responsible access device of the user terminal and a few of next successors thereof in the hash space are responsible for, wherein the responsible access device has a Node ID in the hash space closest to the User ID of the user terminal.

In accordance with still another aspect of the present invention, a method for establishing a session in a network communication system.

The network communication system comprises a P2P network and a plurality of user terminals. The P2P network comprises a plurality of access devices acting as nodes thereof. And each of the user terminals is connected to the P2P network by an access device thereof. Each of the access devices is responsible for a hash area, which forms a hash space of the P2P network together with hash areas that other access devices in the P2P network are responsible for. The access device comprises a SIP interface, an adapter module and a DHT module. The adapter module converts a SIP message received from the user terminal through the SIP interface to a P2P message and sends it to the DHT module, and converts result from the DHT module to a SIP response message, and sends it to the user terminal through the SIP interface.

The method comprises following steps:
a caller user terminal hashes user name of a called user terminal to obtain a User ID of the called user terminal;
the caller user terminal constructs a SIP invite message with the User ID and sends to the access device thereof;
the adapter of the access device thereof converts the SIP invite message received from the caller user terminal through the SIP interface to a corresponding P2P message and then sends to the DHT module;
the DHT module looks up a responsible access device of the called user terminal with the User ID in the P2P message, and then retrieves the registration information of the called user terminal from the hash area that the responsible access device is responsible for, wherein the responsible access device has a Node ID closest in the hash space to the User ID of the user terminal;
the DHT module returns the registration information retrieved from the responsible access device to the adapter module in a P2P message;
the adapter module converts the P2P message from the DHT module to a SIP redirect message including the registration, and then sends to the caller user terminal through the SIP interface;
the caller user terminal resends a SIP invite message to the called user terminal according to the registration information; and
the called user terminal responds with a SIP message to establish a session.

As compared with existing centralized SIP systems, the P2P SIP enabled network according to the present invention is more robust and more scalable. It also could avoid the “single point failure” problem, and still work when several P2P peers fail down before or after the call ring tone starts. Furthermore, the present invention also has other advantages over conventional P2P based multimedia communication implementations, such as using standard SIP protocol, being a fully distributed system, and using the more robust and efficient DHT-based lookup.

### BRIEF DESCRIPTION OF THE DRAWINGS

FIG. 1 is a flow diagram showing call of an existing SIP system;

FIG. 2 shows concept of an existing “P2P over SIP” system;

FIG. 3 shows concept of an existing “SIP using P2P” system;

FIG. 4 shows system structure of an existing “SIP using P2P” system;

FIG. 5 shows concept of a P2P SIP enabled network based on “SIP using P2P” in accordance with an embodiment of the present invention;

FIG. 6 shows architecture of a P2P SIP enabled network based on “SIP using P2P” in accordance with an embodiment of the present invention;

FIG. 7 shows system structure of a P2P SIP enabled network based on “SIP using P2P” in accordance with an embodiment of the present invention;

FIG. 8 shows communication between two terminals in accordance with an embodiment of the present invention;

FIG. 9 shows a process for constructing a P2P network in accordance with an embodiment of the present invention;

FIG. 10 shows a process for registering an user with the P2P SIP enabled network in accordance with an embodiment of the present invention; and

FIG. 11 shows a process for managing a call in the P2P SIP enabled network in accordance with an embodiment of the present invention.

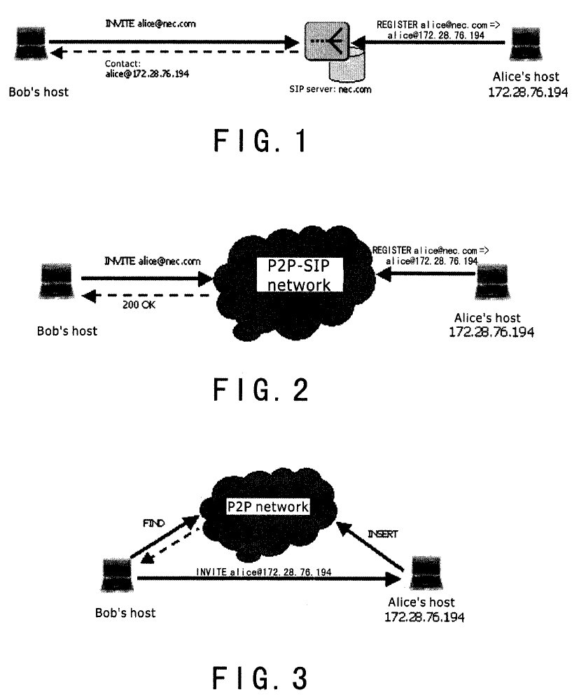

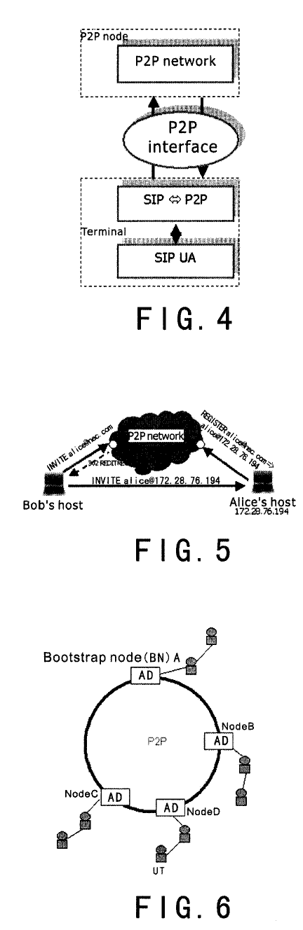

### DETAILED DESCRIPTION OF PREFERRED EMBODIMENT

Hereinafter, the present invention will be described with reference to drawings.

First, the concept of “SIP using P2P” according to the present invention will be explained with reference to FIG. 5.

As shown in FIG. 5, Alice's host has registered with the P2P SIP enabled network with mapping between user name and address thereof. Bob's host, which has registered with the network, then calls Alice's host by sending an INVITE alice@(nec.com message with the user name of Alice's host to the network. The network sends back a 302 REDIRECT message, which contains IP address of Alice's host. Bob's host now can communicate with Alice's host using the IP address.

In process of registration, invitation and subsequent communication, the messages that Bob's host and Alice's host use to communicate are all standard SIP messages. These messages are converted to P2P messages that supported by the underlying P2P network in nodes of the network, in order to access services supplied by the P2P network.

Accordingly, the underlying P2P network can be implemented by using any algorithm. The algorithm used to implement the network is transparent to Alice's host and Bob's host. The two hosts communicate each other as if they were communicating through a SIP network.

This implementation is similar to one that a SIP layer is placed above a P2P network layer. Therefore, the network in accordance with the present invention is referred to a P2P SIP enabled network.

Next, the architecture of the P2P SIP enabled network based on “SIP using P2P” in accordance with an embodiment of the present invention will be described with reference to FIG. 6.

Unlike a traditional SIP architecture, the network based on “SIP using P2P” in accordance with the present invention requires no central servers. As shown in FIG. 6, the network based on “SIP using P2P” includes two different entities, APs (Access Points) and user terminals (MH, Mobile Host). Rather than a traditional SIP architecture where many SIP UAs connect to a central proxy server, the APs (peers) connect directly to a few other APs (peers), forming a virtual network of peers referred to as a P2P network.

The APs participating in this overlay act as traditional SIP outbound proxy servers for user terminals and allow user terminals to place and receive calls, but, when viewed collectively with the other peers, perform the roles of registrar, redirection server and location server in traditional SIP networks. Accordingly, when viewed as a whole, they form a P2P SIP enabled network.

User terminals only act as SIP user agents. A Multimedia session, such as audio, video and instant message session, through the P2P SIP enabled network can be established among two or more user terminals.

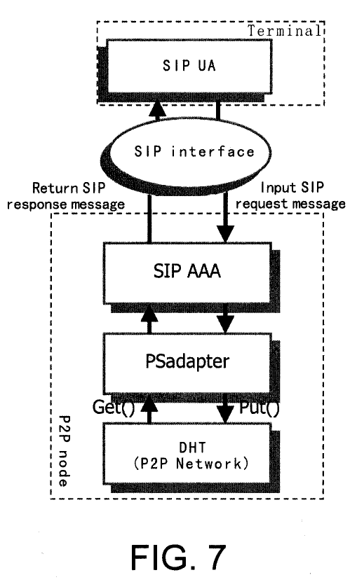

Below, detailed description of above two entities and relations between them will be given with reference to FIG. 7. FIG. 7 shows system structure of a P2P SIP enabled network based on “SIP using P2P” in accordance with an embodiment of the present invention.

As shown in FIG. 7, an AP acting as a P2P node mainly comprises three modules, a P2P DHT (Distributed Hash Table) module (in this embodiment, it is a Bamboo P2P DHT module), a PSadapter (an adapter) module and a SIP AAA module. In addition, the AP further provides a SIP interface for exchanging SIP messages with external user terminals.

DHT module in an AP is connected to other DHT modules in other APs, forming a P2P network. A DHT module also maintains a hash area. Hash areas in DHT modules of APs in the P2P network form a hash space of the P2P network together. These hash areas are implemented as distributed hash tables. For redundancy, registration information of an access user terminal is stored in a plurality of hash areas, which also avoids the “single point failure” problem. Moreover, a session among two or more user terminals can be established using registration information obtained by looking up in the hash space.

In this embodiment, the P2P network is a DHT P2P overlay network, which provides accessible DHT services using Bamboo algorithm. A DHT module provides two functions interface, which provides the services. Put( ) function is responsible to save user registration information to P2P network and Get( ) is responsible to retrieve user information from P2P network.

APs also act as SIP proxy for user terminals and perform certain SIP server functions, such as registration, location and redirect functions, These functions are performed by PSadapter module in the AP. So actually, the PSadapter module is an adapter, which implements the transition between SIP protocol and P2P protocol. The PSadapter module converts SIP messages from user terminals to P2P messages, and then sends them to P2P network through DHT module. Similarly, the PSadapter module also converts P2P messages from P2P network through the DHT module to SIP messages and sends them to external user terminals. Accordingly, when viewed as a whole, APs connected each other form a P2P SIP enabled network providing SIP services.

In this embodiment, the implementation of PSadpter module is based on well-known OSIP open source SIP stack.

What's more, a SIP AAA module is placed between the PSadapter module and the SIP interface. It performs the authentication, authorization and accounting functions for the access terminals. The SIP AAA module is easy to implement for there are many mature solutions in existing SIP. Therefore, the detained description of the SIP AAA module is omitted.

An AP also provides a SIP interface for exchanging SIP messages with user terminals. In this embodiment, the SIP interface is a standard SIP interface.

Standard input SIP request messages from a user terminal are inputted through the SIP interface. After the SIP AAA module performs authentication, authorization and accounting functions, these message are further sent to the PSadapter module. The PSadapter module converts them to corresponding P2P message for accessing P2P services.

Similarly, P2P messages from P2P network through the DHT module are converted to SIP messages and then sent to the SIP AAA module for corresponding processes by the PSadapter module. These messages then are sent to user terminal through the SIP interface as return SIP response messages.

Actually, a user terminal is a standard SIP user agent, which mainly comprises a SIP UA module. For a user terminal, the above P2P SIP enabled network is the same as a normal SIP network. A user terminal registers with the P2P SIP enabled network using a standard SIP message. The message is converted by an access AP of the user terminal. The user terminal is then registered with the P2P network using the converted message.

Hereafter, the user terminal can establish a session with any user terminals that have registered with the network and perform communication with them using standard SIP messages.

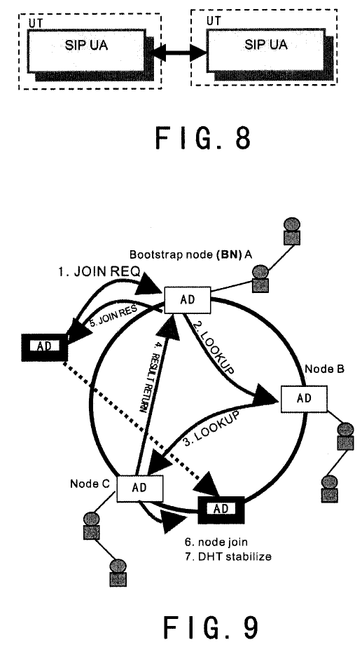

The underlying P2P network is transparent to user terminals. They do not care operations of the P2P network. SIP UAs between a session communicate each other as if they were communicating directly using standard SIP messages. FIG. 8 shows this case.

Below, processes for constructing the “SIP using P2P” network and for communication through the network in accordance with the present invention are described particularly.

APs are organized using a Distributed Hash Table (DHT) P2P structure as nodes. In such a system, every user has a User-ID, which is obtained by hashing user name, such as alice@(nec.com. Users'registration information can be thought of as being stored in the distributed hash table at the entry corresponding to their User-ID. The APs that make up the P2P network are also assigned an ID, called a Node-ID, which is obtained by hashing the IP address of APs and maps to the same hash space as the User-IDs. An AP that has a Node-ID near a particular User-ID will be responsible for storing the registration information about that user. The hash space is divided up so that all of the hash space is the responsibility of some particular node, although as APs enter and leave the system, the hash area that any particular node is responsible for may shrink or grow. Messages are exchanged between the nodes in the DHT as the APs enter and leave. Additionally, redundancy is implemented to protect against an AP failing.

Each AP keeps information about how to contact other APs in the P2P network. In terms of the P2P network, these are the neighbors of the node. When locating user info with a particular User-ID, the node will send the request to the neighbor with the Node-ID closest in the hash space to the desired User-ID. Since the node receiving the request has many neighbors with similar Node-IDs, it will presumably know of a node with a Node-ID closer to the User-ID. The request is then forwarded to this closer node. The process is repeated until the node responsible for the User-ID is located and the requested information is obtained.

When a node wishes to join the P2P network, it will send a JOIN REQUEST message to a bootstrap node already in the P2P network, requesting to join. In response, some messages are exchanged to allow the bootstrap node to obtain the information about user information the joining node will be responsible for maintaining. Other messages will be exchanged later to maintain the P2P network as other nodes enter and leave, but once the initial set messages are exchanged, a node has joined the overlay.

As an example, we illustrate the P2P network construction process as shown in FIG. 9. The process comprises following steps:
Joining node wants to join P2P network, he only knows the BN is node A, so send join request to BN node A via step 1;
Node A look up the location joining node should be located in P2P network via step 2,3;
Node C return search result to Node A via step 4;
Node A sends result to joining node to tell him the location in DHT via step 5;
Joining node joins the P2P network;
Node C sends joining node some information to stabilize the P2P network.

Once a node (AP) has joined the P2P network, the user (in user terminal) that node is responsible for must be registered with the P2P network. This registration is analogous to the traditional SIP registration, in which a message is sent to the registrar creating a mapping between a SIP URI and a user's contact. The only difference is that since there is no central registrar, some node in the DHT will maintain the registration on the user's behalf.

The user terminal will hash the user name, such as alice@(nec.com resulting in a User-ID corresponding to that user name. A SIP REGISTER message containing contact information for the user is constructed and sends to related access AP. The access node (AP) will look up the node it is aware of with a Node-ID nearest the User-ID calculated from the user's name, and forward the message to this node. The process is repeated until the LOOKUP message reaches the node responsible for the portion of the hash space that includes the hashed User-ID. Then the access AP sends related messages to store the registration for that user in the responsible AP. For redundancy, the user should also store the registration at some other nodes immediately following the responsible node.

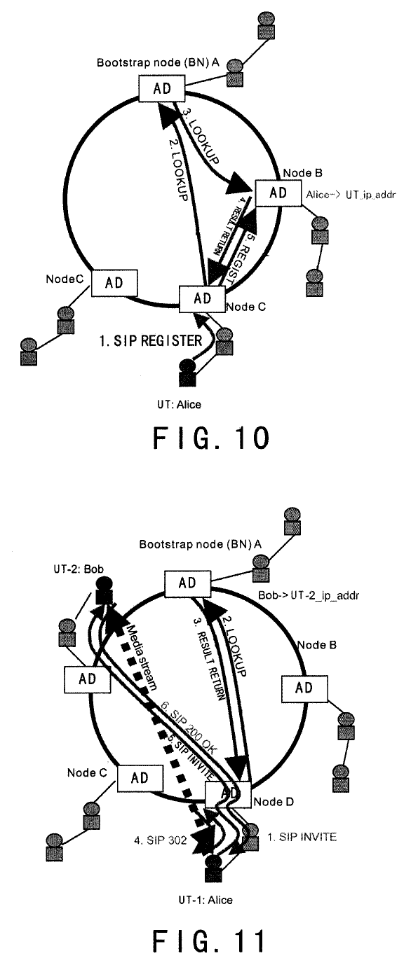

As an example, we illustrate the shared data management process (user terminal registration process) as shown in FIG. 10. The process comprises following steps:
Alice in MH sends SIP REGISTER message to its associated AP D via step 1;
AP D looks up the responsible node for storing Alice registration information in DHT via step 2,3;
AP B returns result to AP D via step 4;
AP D registers Alice information: alice@nec.com -> MH_ip_addr mapping in AP B via step 5;
For redundancy and reliability, user registration information can be saved in the responsible node and its next x successors.

P2P SIP Enabled V2oIP Call Management (Session Establishment)

After registering with the P2P network, a user terminal can establish a session with other HMs. Establishing a session works very much like user registration information storage process. The caller's user terminal constructs an SIP INVITE message, and hashes the name of the called. The caller's access AP sends the LOOKUP message to the AP (node) nearest the hashed name that it is aware of. When lookup result returning, the access AP sends back a 302 to the caller's user terminal where the contact is the actual address of the called's user terminal. When the caller resends the message to that user terminal, the call is completed in the conventional SIP format.

As an example, we illustrate the P2P SIP enabled V2oIP call process as shown in FIG. 11. The process comprises following steps:
Alice in MH-1 sends SIP INVITE (Bob) message to its associated AP D via step 1;
AP D looks up the responsible node for storing Bob registration information in DHT via step 2;
AP A return result to AP D to tell the Bob@nec.com-> MH-2_ip_addr mapping via step 3;
AP D sends SIP 302 to Alice in MH-1 to tell the Bob MH-2_ip_addr via step 4;
Alice resends SIP INVITE to MH-2 via step 5;
Bob responds Alice a SIP OK via step 6;
After P2P authentication Alice and Bob begin talk.

Although the present invention has been described with respect to specific embodiments thereof, various changes and modifications may be suggested to one skilled in the art. It is intended such changes and modifications fall within the scope of the appended claims.

What is claimed is:

1. An access device, which acts as a node in a P2P network, the P2P network comprising a plurality of the access devices, wherein
each of the access device is responsible for a hash area, which forms a hash space of the P2P network together with hash areas that other access devices in the P2P network are responsible for, each of the access device comprises:
a SIP interface;
an adapter module; and
a DHT module, which connects to DHT modules in some of the plurality of the access devices in the P2P network, wherein
the adapter module receives a SIP request message from a user terminal, which is connected to the P2P network by the access device, converts the SIP request message to a P2P message and then sends it to the DHT module, and converts result from the DHT module to a SIP response message, and sends it to the user terminal through the SIP interface, and
the DHT module performs a registration operation and look up operation based on the P2P message, and returns the result to the adapter module, wherein the registration operation is used to save registration information of the user terminal in the P2P network, and the look up operation is used to retrieve registration information of another user terminal from the P2P network so as to establish a session between the user terminal and the another user terminal.

2. The access device of claim 1, further includes an AAA server module between the SIP interface and the adapter module for operation of authentication, authorization and accounting.

3. The access device of claim 1, wherein the adapter module uses two function interfaces provided by the DHT module to call the DHT module, wherein one is used to perform the registration operation, and the other is used to perform the look up operation.

4. The access device of claim 1, wherein the registration information is saved in hash areas that responsible access device of the user terminal and a few of next successors thereof in the hash space are responsible for, wherein the responsible access device has a Node ID in the hash space closest to the User ID of the user terminal, the user terminal hashes the user name thereof to obtain the User ID.

5. The access device of claim 4, wherein, in the hash space, the registration information of the user terminal is indexed with the User ID.

6. The access device of claim 1, wherein the registration information of the user terminal comprises mapping of the user name and IP address thereof.

7. The access device of claim 1, wherein the DHT module is one of Bamboo, Chord, Pastry, CAN and Tapstry P2P DHT modules.

8. A network communication system, comprising:
a P2P network, which comprises a plurality of access devices acting as nodes thereof, wherein each of the access device is responsible for a hash area, which forms a hash space of the P2P network together with hash areas that other access devices in the P2P network are responsible for, the access device comprises:
a SIP interface;
an adapter module; and
a DHT module, which connects to DHT modules in some of the plurality of the access devices in the P2P network, wherein the adapter module receives a SIP request message from a user terminal, which is connected to the P2P network by the access device, converts the SIP request message to a P2P message and then sends it to the DHT module, and converts result from the DHT module to a SIP response message, and sends it to the user terminal through the SIP interface, and
the DHT module performs a registration operation and look up operation based on the P2P message, and returns the result to the adapter module, wherein the registration operation is used to save registration information of the user terminal in the P2P network, and the look up operation is used to retrieve registration information of another user terminal from the P2P network so as to establish a session between the user terminal and the another user terminal; and
a plurality of user terminals, each of the user terminal is connected to the P2P network by an access AD thereof, the user terminal comprises a user agent for sending/receiving a SIP request message/SIP response message to/from the access AD thereof, in order to register with the P2P network and establish a session between the user terminals.

9. The network communication system of claim 8, further includes an AAA module between the SIP interface and the adapter module for operation of authentication, authorization and accounting.

10. The network communication system of claim 8, wherein the adapter module uses two function interfaces provided by the DHT module to call the DHT module, wherein one is used to perform the registration operation, and the other is used to perform the look up operation.

11. The network communication system of claim 8, wherein the registration information is saved in hash areas that responsible access device of the user terminal and a few of next successors thereof in the hash space are responsible for, wherein the responsible access device has a Node ID in the hash space closest to the User ID of the user terminal, the user terminal hashes the user name thereof to obtain the User ID.

12. The network communication system of claim 11, wherein, in the hash space, the registration information of the user terminal is indexed with the User ID.

13. The network communication system of claim 8, wherein the registration information of the user terminal comprises mapping of the user name and IP address thereof.

14. The network communication system of claim 8, wherein the DHT module is one of Bamboo, Chord, Pastry, CAN and Tapstry P2P DHT modules.

15. The network communication system of claim 8, wherein the SIP user agent is a standard SIP user agent.

16. The network communication system of claim 11, wherein the user agent hashes the user name.

17. The network communication system of claim 8, wherein the session is a multimedia session, which includes video and voice.

18. A method for registering a user terminal with a network communication system, wherein the network communication system comprises a P2P network and a plurality of user terminals, the P2P network comprises a plurality of access devices acting as nodes thereof, and each of the user terminal is connected to the P2P network by an access device thereof,
each of the access device is responsible for a hash area, which forms a hash space of the P2P network together with hash areas that other access devices in the P2P network are responsible for,
the access device comprises a SIP interface, an adapter module and a DHT module, the adapter module converts a SIP message received from the user terminal through the SIP interface to a P2P message and sends it to the DHT module, and converts result from the DHT module to a SIP response message, and sends it to the user terminal through the SIP interface, the method comprises:
the user terminal hashes user name thereof to obtain a User ID;
the user terminal constructs a SIP registration message with the User ID and sends it to the access device thereof, wherein the SIP registration message comprises registration information of the user terminal;
the adapter of the access device thereof converts the SIP registration message received from the user terminal through the SIP interface to a corresponding P2P message and then sends it to the DHT module; and
the DHT module looks up a responsible access device of the user terminal, and makes the registration information be saved in the hash areas that the responsible access device of the user terminal and a few of next successors thereof in the hash space are responsible for, wherein the responsible access device has a Node ID in the hash space closest to the User ID of the user terminal.

19. The method of claim 18, wherein the access device further includes an AAA module between the SIP interface and the adapter module for operation of authentication, authorization and accounting.

20. The access device of claim 18, wherein the registration information of the user terminal comprises mapping of the user name and IP address thereof.

21. The method of the claim 18, wherein the DHT module is one of Bamboo, Chord, Pastry, CAN and Tapstry P2P DHT modules.

22. A method for establishing a session in a network communication system, the network communication system comprises a P2P network and a plurality of user terminals, the P2P network comprises a plurality of access devices acting as nodes thereof, each of the user terminal is connected to the P2P network by an access device thereof,
each of the access device is responsible for a hash area, which forms a hash space of the P2P network together with hash areas that other access devices in the P2P network are responsible for,
the access device comprises a SIP interface, an adapter module and a DHT module, the adapter module converts a SIP message received from the user terminal through the SIP interface to a P2P message and sends it to the DHT module, and converts result from the DHT module to a SIP response message, and sends it to the user terminal through the SIP interface, the method comprises:
a caller user terminal hashes user name of a called user terminal to obtain a User ID of the called user terminal;
the caller user terminal constructs a SIP invite message with the User ID and sends to the access device thereof;
the adapter of the access device thereof converts the SIP invite message received from the caller user terminal through the SIP interface to a corresponding P2P message and then sends to the DHT module;
the DHT module looks up a responsible access device of the called user terminal with the User ID in the P2P message, and then retrieves the registration information of the called user terminal from the hash area that the responsible access device is responsible for, wherein the responsible access device has a Node ID closest in the hash space to the User ID of the user terminal;
the DHT module returns the registration information retrieved from the responsible access device to the adapter module in a P2P message;
the adapter module converts the P2P message from the DHT module to a SIP redirect message including the registration, and then sends to the caller user terminal through the SIP interface;
the caller user terminal resends a SIP invite message to the called user terminal according to the registration information; and
the called user terminal responds with a SIP message to establish a session.

23. The method of claim 22, wherein the access device further includes an AAA module between the SIP interface and the adapter module for operation of authentication, authorization and accounting, the method further comprises a step for making authentication on the caller user terminal and the called user terminal.

24. The method of claim 22, wherein the registration information of the user terminal comprises mapping of the user name and IP address thereof.

25. The method of the claim 22, wherein the DHT module is one of Bamboo, Chord, Pastry, CAN and Tapstry P2P DHT modules.
